(19) United States
(12) Patent Application Publication
(10) Pub. No.: US 2022/0040022 A1
(43) Pub. Date: Feb. 10, 2022

(54) TABLE COLUMN FOR AN OPERATING TABLE HAVING A REINFORCING MECHANISM FOR A CYLINDRICAL GUIDE

(71) Applicant: MAQUET GMBH, RASTATT (DE)

(72) Inventors: Mike OBERT, GERNSBACH (DE); Jan Donat OLSZEWSKI, WASCHGASSE (DE)

(21) Appl. No.: 17/280,639

(22) PCT Filed: Sep. 26, 2019
(86) PCT No.: PCT/EP2019/075976

§ 371 Date: Mar. 26, 2021

(30) Foreign Application Priority Data
Sep. 28, 2018 (DE) 10 2018 124 135.6

(51) Int. Cl. A61G 13/06; A61G 13/12

(52) U.S. Cl. CPC A61G 13/06; A61G 13/121

(57) ABSTRACT

A table column (1) for an operating table, having:
a column head support (6);
a column head (7) which is received in the column head support (6) and is height-adjustable in relation to it;
a lifting drive (21) for adjusting the height of the column head (7) in relation to the column head support (6); and
a cylindrical guide (23) that connects the column head (7) to the column head support (6) and is used to guide the column head (7) vertically when it is adjusted in height,
   wherein the cylindrical guide (23) has a longitudinal groove (24) and two keys (26) engaging therein in order to secure the cylindrical guide (23) against rotation around its vertical axis, and wherein each key (26) comprises a main body and an engagement element which protrudes along an engagement direction and which engages in the engagement direction in the longitudinal groove (24), wherein the engagement elements of the two keys (26) are arranged offset to one another transverse to the longitudinal axis of the longitudinal groove (24), so that a pre-tension is generated in the cylindrical guide (23) transversely to the longitudinal axis of the longitudinal groove (24).

### TECHNICAL AREA

The present disclosure relates to table columns for operating tables.

### BACKGROUND OF THE DISCLOSURE

Table columns for operating tables are previously known. They usually comprise a height-adjustable column head, a patient support surface arranged on an upper end of the column head, and a column base for placing the table column on the floor of an operating room.

Before and during an operation, the patient support surface has to be brought into a position that facilitates an intervention on the patient. The height of the patient support surface is to be adjustable in the largest possible range. In addition, it can be necessary to pivot the patient support surface by large angles around an inclination axis and a tilt axis in order to carry out a fine adjustment of the patient support position.

A patient support surface of an operating table that is aligned in this way has to remain stable in the desired position. The use of various stability systems to increase the stability of the height-adjustable column head is known for this purpose.

In spite of the known stability systems, however, there is often a small residual play in the rotational direction of the height-adjustable column head around its vertical axis.

Such play results in a slight wobbling of the patient support surface. Depending on the type of surgical procedure to be carried out, this minimal instability can prove to be enormously disruptive. A sudden slight wobbling of the patient support surface and thus of the patient can negatively affect the work of the surgeon. A risk for the patient thus results.

For example, in cranial and brain operations using special instruments attached to the operating table, there is a great need for a particularly stably and rigidly embodied table column. In particular, the residual play just described is unacceptable in such an application.

### SUMMARY OF THE INVENTION

One object of the present disclosure is to provide an adjustable table column, the stability and rigidity of which against rotation around its vertical axis is increased.

According to the present disclosure, this object is achieved with a table column for an operating table, which has at least one of the following features:
a column head support;
a column head which is received in the column head support and is height-adjustable in relation to it;
a lifting drive for adjusting the height of the column head in relation to the column head support; and
a cylindrical guide that connects the column head to the column head support and is used to guide the column head vertically when it is adjusted in height,
   wherein the cylindrical guide has a longitudinal groove and two keys engaging therein in order to secure the cylindrical guide against rotation around its vertical axis,
   wherein each key comprises a main body and an engagement element protruding along an engagement direction, which engages in the longitudinal groove in the engagement direction, and
   wherein the engagement elements of the two keys are arranged offset to one another transversely in relation to the longitudinal axis of the longitudinal groove, so that a pre-tension is generated in the cylindrical guide transversely to the longitudinal axis of the longitudinal groove.

Due to the special design of the present table column having a column head, a column head support, and a cylindrical guide comprising two parallel keys, which connects the column head to the column head support and is used to guide the column head vertically when it is adjusted in height, even a small amount of rotational play in the rotational direction around a vertical axis of the table column is eliminated.

More precisely, the special offset arrangement of the engagement elements formed on the keys prevents any rotational play.

The offset of the two engagement elements can consist of at least one of the engagement elements being arranged eccentrically on its main body.

The offset of the two engagement elements can also consist of the main bodies associated with the engagement elements being arranged on the column head support with an offset to one another.

The engagement elements can be wedge-shaped.

The keys can be arranged vertically one above the other along the longitudinal axis of the longitudinal groove.

Each key (26) can be associated with a readjustment device for automatic readjustment of its seat within the longitudinal groove.

The readjustment device can be designed to be operated by spring force.

It can also comprise a set of disc springs. In addition, each readjusting device can have an adjusting screw for adjusting the spring force.

The keys can be introduced into bores in the column head support.

The cylindrical guide can comprise a central, non-driven lifting cylinder. The lifting cylinder can be adjustable in a passive telescopic manner in order to follow the movement of the column head during its height adjustment. The table column can furthermore comprise at least one lifting cylinder drivable by means of a lifting drive.

The table column according to the disclosure can furthermore comprise an attachment unit arranged at an upper end of the table column. The attachment unit can be used to attach a patient support surface to the table column.

In addition, the table column can have a plurality of lifting cylinders, wherein the cylindrical guide and the lifting cylinders can be connected to the attachment unit by means of articulated connections.

The cylindrical guide and the lifting cylinders can be designed to incline the attachment unit around a longitudinal axis of the patient support surface and to tilt it around an axis extending transversely to the longitudinal axis of the patient support surface.

The present table column can furthermore comprise a main lifting device which is telescopically adjustable by means of a drive. The main lifting device can be designed to vertically adjust the column head support and the cylindrical guide connected to it.

The keys can be introduced into the column head support. The engagement elements of the keys can be pre-tensioned in the longitudinal groove by means of spring force. In addition, the longitudinal groove can be designed to slide over the engagement elements of the keys.

The main bodies of the present keys can be arranged in the column head support. The longitudinal groove can be designed as a groove extending vertically in the central lifting cylinder of the column head. During the height adjustment of the column head in relation to the column head support, the longitudinal groove can slide vertically over the engagement elements of the keys.

The present disclosure also relates to operating tables having the above-defined table column, as well as their use in surgical interventions.

### BRIEF DESCRIPTION OF THE DRAWINGS

Exemplary embodiments of the present disclosure are explained in more detail below using the figures. In the figures:

FIG. 1 shows an overview of an operating table having an operating table column according to the present disclosure;

FIG. 2 shows a perspective view of the operating table column of FIG. 1 without cover having a column shaft and an attachment unit for a patient support surface:

FIG. 3 shows a perspective side view of the table column of FIG. 2 including a cylindrical guide having two keys and a groove:

FIG. 4 shows a longitudinal sectional illustration of a section of the cylindrical guide along line I-I in FIG. 3:

FIG. 5 shows a perspective view of a section of the cylindrical guide of FIGS. 3 and 4 having a cross-sectional illustration of one of the two keys along line II-II from FIG. 3;

FIG. 6 shows another perspective view of the cylindrical guide of FIGS. 3-5 having a cross-sectional view of a second key along line III-III from FIG. 3;

FIG. 7 shows a detail of a cross section through a column head carrier of the table column of FIG. 2 having a central cylinder arranged therein including a bore for receiving a key.

### DETAILED DESCRIPTION

In the following description, exemplary embodiments of the present disclosure are described with reference to the drawings. The drawings are not necessarily true to scale, but are only intended to illustrate the respective features schematically.

It is to be noted that the features and components described below can each be combined with one another, regardless of whether they have been described in conjunction with a single embodiment. The combination of features in the respective embodiments is used only to illustrate the basic structure and the mode of operation of the claimed device.

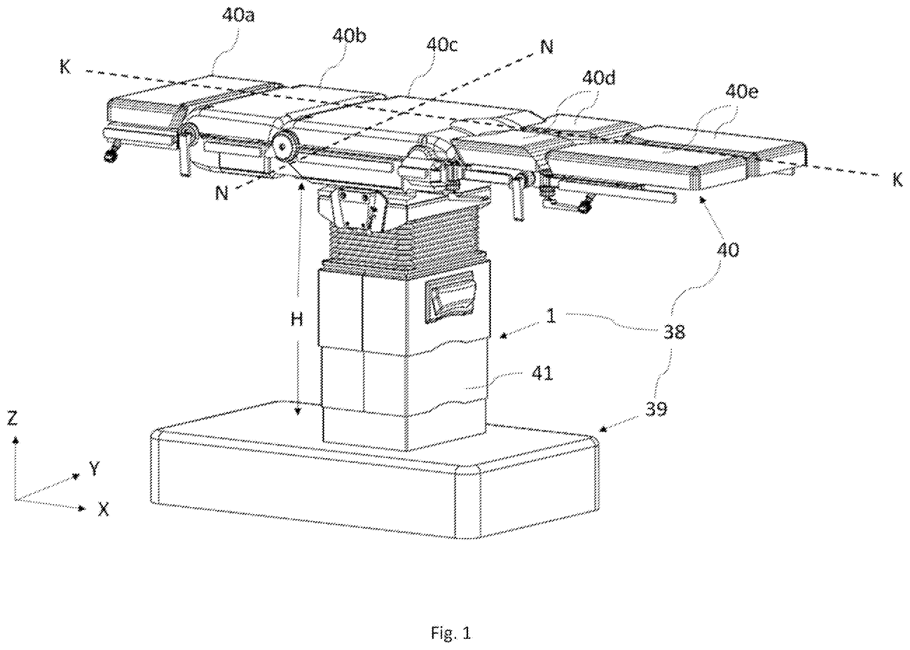

FIG. 1 shows an operating table 38 according to the disclosure. This operating table 38 is used for a wide variety of surgical interventions. For this purpose, the patient to be operated on is positioned on the operating table 38.

The operating table 38 comprises, from bottom to top, a base 39, an operating table column 1, and a patient support surface 40. The operating table column 1 is seated on the base 39. The patient support surface 40 is removably fastened on the table column 1.

The height H of the operating table column 1 can be adjusted. Its internal mechanism is protected by a cover 41.

The patient support surface 40 can be pivoted around a tilt axis K-K and an inclination axis N-N. The patient support surface 40 has a modular structure and is expandable as required. It has the following removable modules: a head module 40a, two back modules 40b and 40c, and two leg modules 40d, 40e.

During an operation, the position of a patient lying on the patient support surface 40 can be changed by raising or lowering the operating table column 1 and/or pivoting the patient support surface 40 around one or both of its pivot axes K-K and N-N.

For better illustration of the components of the operating table column 1, a Cartesian coordinate system X-Y-Z is shown in the figures. The Z-axis is the vertical axis, the X-axis and the Y-axis are the horizontal axes. The X-axis extends in the longitudinal direction of the base 39 from a patient head end of the operating table 38 to its patient foot end, which respectively correspond to the head module 40a and the outer leg module 40e of the patient support surface 40. The Y-axis extends transversely to the X-axis.

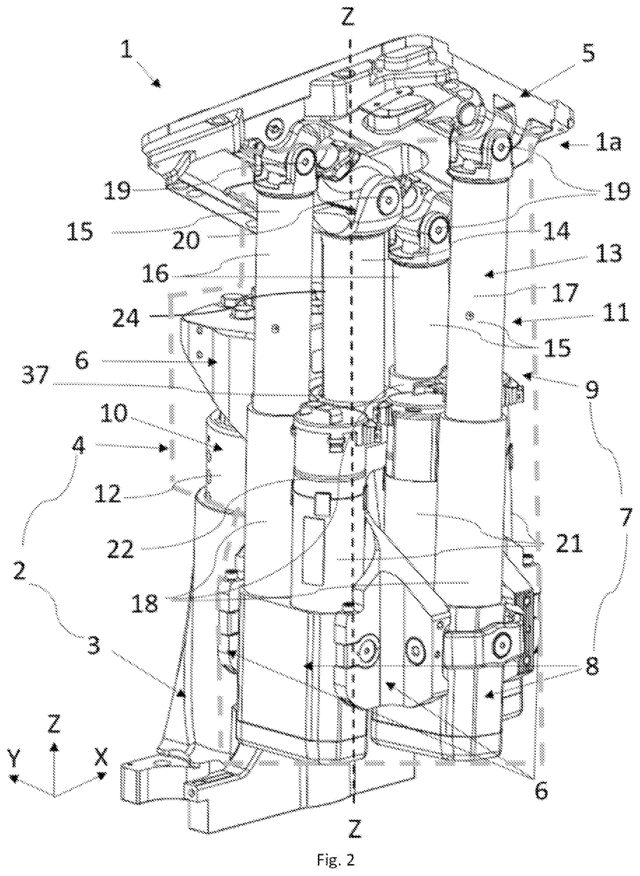

FIG. 2 shows an adjustable table column 1 for an operating table according to one embodiment of the present disclosure. More precisely, FIG. 2 shows the inner workings of the table column 1 from FIG. 1. Accordingly, the cover 41 is not shown.

This table column 1 comprises a height-adjustable column shaft 2 and an attachment unit 5, which is arranged at an upper end of the column shaft 2, for attaching the patient support surface 40 to the table column 1.

The column shaft 2 is subdivided into a lower stationary column shaft socket 3 and an upper column shaft trunk 4 which can be moved up and down relative to the column shaft socket 3. The column shaft trunk 4 comprises all components that are located within the detail delimited by the dashed line. In particular, the column shaft trunk 4 comprises two weight-bearing main components, namely a column head support 6 arranged in a lower section of the column shaft trunk 4, as well as a column head 7 which is supported by the pillar column support 6. The two main components 6, 7 of the column shaft trunk 4 are additionally used as attachment elements for adjacent structural components of the table column 1.

The column head 7 extends between the column head support 6 and the attachment unit 5. The column head 7 is divided into a column head base 8 and a column head adjustment unit 9 which is adjustable in height in relation to the column head base 8.

In some embodiments, the attachment unit 5 has a rectangular layout and is used for the releasable fastening of the patient support surface 40 on the table column 1.

For height adjustment, the table column 1 shown in FIG. 2 has a main lifting device 10 and an auxiliary lifting device 11.

The main lifting device 10 is designed as a first cylindrical telescopic guide 12. The column head support 6 is fastened on the upper end of the first telescopic guide 12. With the main lifting device 10, the column shaft trunk 4 and thus also the column head support 6 can be moved up and down relative to the column shaft socket 3.

The auxiliary lifting device 11 is designed as a second cylindrical telescopic guide 13. The attachment unit 5 is fastened on the upper end of the second telescopic guide 13. Using the auxiliary lifting device 11, the column head adjustment unit 9 can be moved up and down relative to the column head base 8 parallel to the Z-axis (FIG. 2).

The auxiliary lifting device 11 of the column head 7 is at the same time an inclination device 16 and a tilt device 17. Using the inclination device 16, the attachment unit 5 can be inclined around the Y-axis. Using the tilt device 17, the attachment unit 5 can be tilted around the X-axis.

All adjustment movements are possible individually but also combined with one another in any way. As a result, the tilt and the inclination of the patient support surface 40 can be easily adjusted.

The construction of the column head 7 enables a height adjustment of the attachment unit 5 along the Z-axis (translational degree of freedom) and its pivoting around the X- and Y-axis (two rotational degrees of freedom). A displacement of the column head adjustment unit 9 parallel to the X and Y axes, as well as a rotation around the Z axis, has to be excluded, however.

The device 11, 16, 17 designed for lifting, tilting, and inclination comprises a group of four lifting cylinders 14, 15 which are adjustable along the vertical Z-axis and which are each arranged in outer cylindrical guides 18 (FIG. 2). A central lifting cylinder 14 is surrounded by three peripheral lifting cylinders 15. The peripheral lifting cylinders 15 are spaced from one another and their upper ends are each connected to the lower side of the attachment unit 5 by means of a joint 19. The two opposite lifting cylinders 15 belong to the inclination device 16. The remaining third lifting cylinder 15 belongs to the tilt device 17. The attachment unit 5 is linked to the central lifting cylinder 14 via a central joint 20. The joint 20 is, for example, a cardan ball joint or a cardan universal joint.

The table column 1 shown in FIG. 2 furthermore comprises a lifting drive 21 for adjusting the height of the column head 7 in relation to the column head carrier 6. For each of the three extendable peripheral lifting cylinders 15, a separate, for example electronically controlled linear motor drive 21 is provided in each case for this purpose. The three linear motor drives 21 are positioned in a housing in the column head base 8 and each have a brake having a sensor 22. The central lifting cylinder 14 shown in FIG. 2 does not have its own drive. In other embodiments of the table column 1, however, the central lifting cylinder 14 can have its own drive.

By means of such an embodiment of the table column 1, the attachment unit 5 or a patient support surface 40 connected to it can be inclined or its tilt can be changed by different positioning movements. In addition, with a simultaneous positioning movement of the three linear motor drives 21 in the same adjustment direction, the height of the attachment unit 5 can be changed, i.e., it can be raised or lowered without its tilt or inclination being changed.

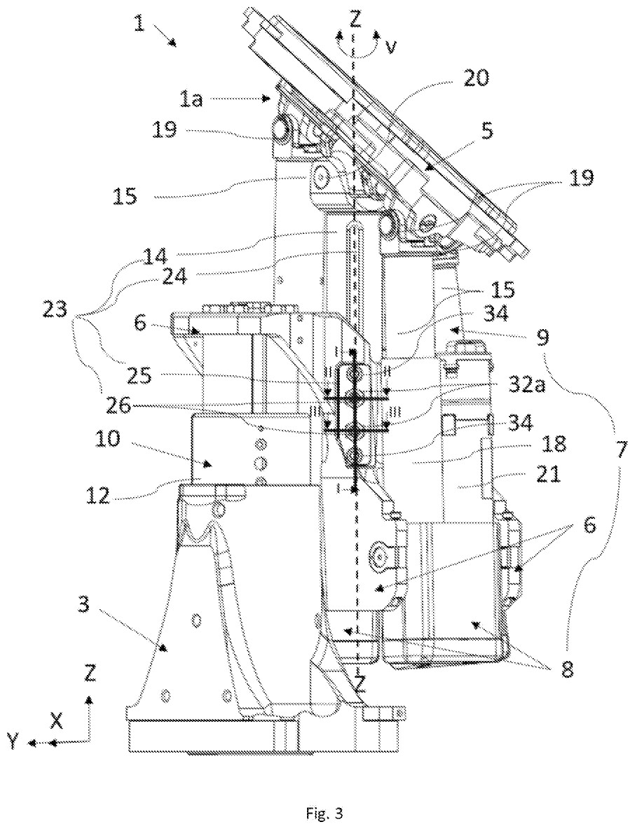

FIG. 3 shows a side view of the table column 1 from FIG. 2, in which the attachment unit 5 is inclined around the Y axis. A cylindrical guide 23 can be seen there, which connects the column head adjustment unit 9 of the column head 7 to the column head support 6. The cylindrical guide 23 has two main components. On the side of the column head adjustment unit 9, this is a movable cylinder. This is the central lifting cylinder 14. On the side of the column head support 6, it is a cylindrical guide hole 37 complementary to the central lifting cylinder 14, see FIG. 2. The central lifting cylinder 14 is received in the cylindrical guide hole 37 and can be extended out of it and retracted back into it.

One task of the central lifting cylinder 14 together with the joint 20 is to block an undesired translation and rotation of the column head adjustment unit 9 in each case along the X and Y axes and around the Z axis. The construction of the column head 7 according to the disclosure is designed in such a way that the functionality of the inclination device 16 and the tilt device 17 is not impaired.

For this purpose, the cylindrical guide 23 comprises a groove 24 and a stability bar 25 together with two keys 26, see FIG. 3.

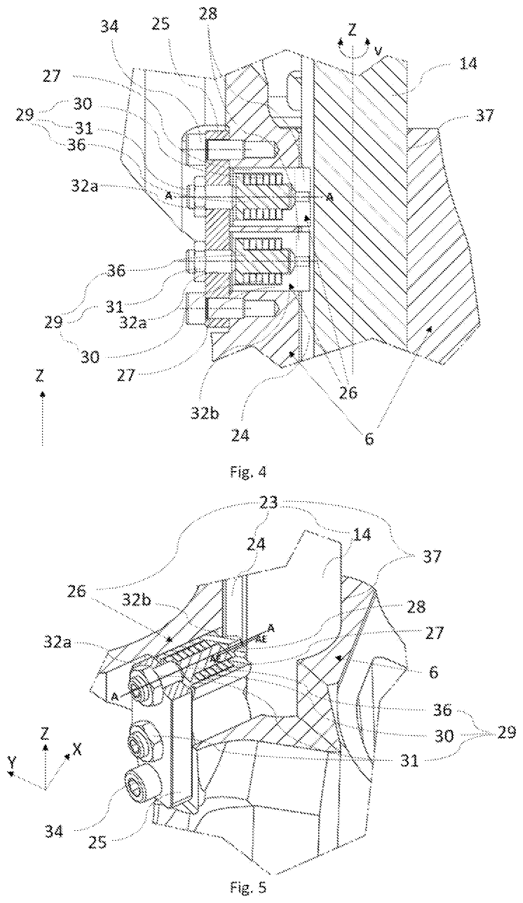

FIG. 4 shows, in a schematic longitudinal sectional illustration along line I-I from FIG. 3, the stability bar 25 together with the two parallel keys 26 cooperating with the longitudinal groove 24 of the central lifting cylinder 14.

In the embodiment shown in FIG. 3, the groove 24 is formed as a slot-like longitudinal groove extending parallel to the Z axis in the lateral surface of the central lifting cylinder 14.

The stability bar 25 is in particular a vertically aligned plate which is designed to increase the stability of the cylindrical guide 23 (FIG. 3). It can essentially have a cuboid shape. The stability bar 25 comprises two spaced apart bores 32a for receiving adjusting screws 31 (cf. FIGS. 4 and 5). At its two opposite ends, it is fastened on the column head support 6 by means of two fastening elements 34.

A key is a machine element that is used to implement a form-fitting connection between two components. The keys 26 and the groove 24 together form a tongue and groove connection.

According to the disclosure, the keys 26 are inserted in a form-fitting manner with an engagement side 28 into the key groove 24 of the cylinder 14 designed for this purpose. The keys 26 are fixed in bores 32b of the column head support 6, while the engagement section 28 of each key 26, which is received in a formfitting manner in the groove 24, can slide in a longitudinal direction of this key groove 24 when the cylinder 14 is moved relative to the column head support 6. Each key 26 can thus be permanently assembled with the column head support 6 and at the same time have a sliding fit in the cylinder 14. Such an arrangement of each key 26 ensures a stable extension and retraction of the cylinder 14 from the column head support 6 surrounding it.

As shown in FIGS. 4 and 5, the keys 26 of the cylindrical guide 23 are introduced into bores 32b of the column head support 6. Their function is to block the rotation of the central lifting cylinder 14 around the central Z-axis. The keys 26 are arranged vertically one above the other along a longitudinal axis of the longitudinal groove 24.

Each of the two keys 26 comprises an elongated main body 27 having an in particular rectangular longitudinal section and an engagement element 28. The main body 27 extends along a longitudinal axis A-A. The engagement element 28 is wedge-shaped and has a flat tip. It protrudes along an engagement direction (FIGS. 4-6).

In other embodiments, the engagement element 28 according to the disclosure can be formed spherical, conical, triangular, rectangular, or semi-cylindrical. Further shapes of the engagement elements 28 are conceivable which are sufficiently complementary to the groove 24 and ensure that the engagement elements 28 slide along the groove 24. The main body 27 of the keys 26 can, for example, be cylindrical or rectangular or have another basic shape that does not impair its functionality.

As shown in FIGS. 4-6, the two engagement elements 28 of the keys 26 engage in the longitudinal groove 24 in order to secure the central lifting cylinder 14 against rotation around its longitudinal axis Z-Z (see double arrow V).

The cylindrical guide 23 of the present disclosure embodied in this way is provided for the controlled height adjustment of the column head 7. It is part of the second cylindrical telescopic guide 13 of the column head 7. It enables the central lifting cylinder 14 to be retracted into and extended out of the column head support 6.

As shown in FIGS. 4-6, each key 26 is also associated with a readjustment device 29 for automatic readjustment of its seat within the longitudinal groove 24 of the central lifting cylinder 14. Each readjustment device 29 is operated by means of spring force. For this purpose, it has a central, in particular T-shaped body 36 and a set of adjacent disc springs 30, which are arranged concentrically around the body 36 and generate a pre-tension. The setting of the spring force can be controlled by means of an adjusting screw 31 of the readjusting device 29 received in the bore 32a of the stability bar 25 (FIGS. 4 and 5). The adjusting screw 31 is arranged at the outer end of the main body 27 and directed in the engagement direction of the key 26. The engagement elements 28 of the keys 26 are held in the desired position in the longitudinal groove 24 by means of the spring force. If a long-term operation of the table column 1 should lead to wear of the groove 24 and/or the engagement elements 28, the disk springs 30 ensure an automatic readjustment so that the connection between the groove 24 and the engagement element 28 is still provided and a rotational play of the central lifting cylinder 14 around the Z-axis cannot arise.

Since a lifting cylinder 14 stabilized in this way is connected to the lower side of the attachment unit 5 by means of the universal joint 20, and the attachment unit 5 is at the same time pivotably connected to the peripheral lifting cylinders 15 via the joints 19, a simultaneous stabilization of the peripheral lifting cylinders 15 of the second cylindrical telescopic guide 13 against pivoting around the Z-axis is also achieved.

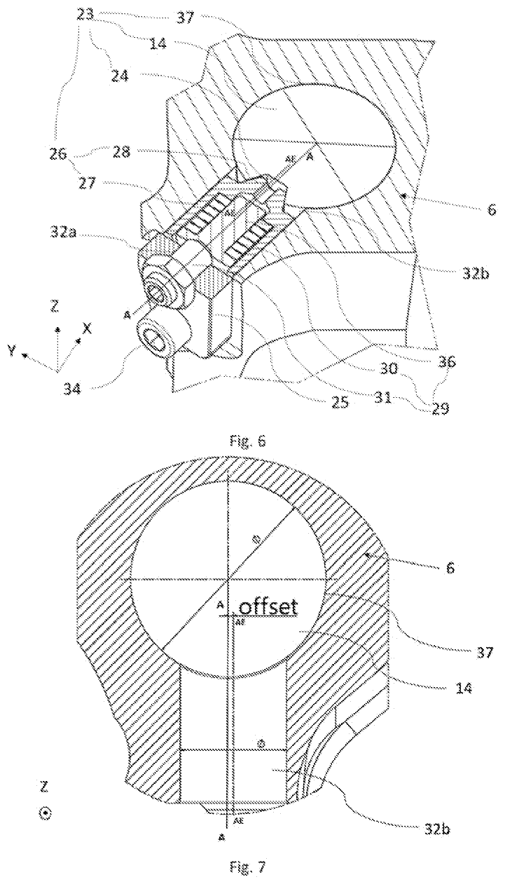

The engagement elements 28 of the keys 26 are arranged offset from one another transversely to the longitudinal axis of the longitudinal groove 24. Such an offset is implemented in the example shown in that at least one of the engagement elements 28 is arranged eccentrically on its main body 27 (FIGS. 5 and 6).

Reference is made to FIG. 7 in this regard. This shows a horizontal section through the cylindrical guide 23. A bore 32b can be seen, wherein the key 26 located therein was omitted.

FIGS. 6 and 7 show the longitudinal axis AE-AE of an engagement element 28, which is offset in parallel relative to the longitudinal axis A-A of the associated main body 27 by a few tenths of a millimeter, for example at least 0.1 mm or at least 0.3 mm. The longitudinal axis AE-AE therefore has no common point of intersection with the central Z-Z axis of the lifting cylinder 14.

In other embodiments, the offset can be achieved in that the main bodies 27 associated with the engagement elements 28 are arranged on the column head support 2 with an offset to one another.

Due to the offset of two keys 26 to one another, their main bodies 27 are pressed in an opposite direction. As a result, a pre-tension is generated in the cylindrical guide 23 transversely to the longitudinal axis of the longitudinal groove 24 and the rotational play in the rotational direction around the axis Z-Z is eliminated.

The present disclosure relates to cylindrical guides 23 which comprise a plurality of keys 26, e.g., two, three, or at least two keys 26.

In some embodiments, the entire bodies of the keys 26 are arranged one below the other in the direction of the vertical axis Z-Z of the lifting cylinder 14 (a so-called vertical arrangement), while each of the keys 26 has an engagement element 28 that is engaged with a groove 24 of the lifting cylinder 14. In some embodiments of the disclosure, only the main bodies 27 of the keys 26, but not the corresponding engagement elements 28, are completely vertically oriented.

For example, the longitudinal axis AE-AE of the engagement element 28 of a first key 26 can be arranged offset in parallel in a first direction relative to the longitudinal axis A-A of the main body 27 of the first key 26. At the same time, the longitudinal axis AE-AE of the engagement element 28 of a second key 26 can either be aligned coaxially with respect to the longitudinal axis A-A of the associated second main body 27 (no offset), or the longitudinal axis AE-AE of the engagement element 28 of the second key 26 can be arranged offset in parallel in a second direction, which differs from the first direction, with respect to the longitudinal axis A-A of the second main body 27.

In other embodiments, all keys 26 can be arranged apart from one another and aligned with one another in the direction of the vertical axis Z-Z of the lifting cylinder 14, while a single key 26 is arranged offset laterally relative to a key 26 arranged above or below it.

The lateral offset of the adjacent engagement elements 28 or keys 26, for example, with respect to lateral surfaces or tips of adjacent engagement elements 28, can be at least 0.1 mm, at least 0.3 mm, 0.1 to 3.0 mm, or 0.3 to 1.0 mm. In some embodiments, adjacent engagement elements 28 can each taper in the direction of one of the two longitudinal sides of the groove 24 or can be pre-tensioned against them in order to exert a stabilizing tension against these two sides of the groove 24.

In some embodiments, two keys 26 are each introduced into bores 32b of the column head support 6 extending perpendicular to the vertical axis Z-Z of the lifting cylinder 14. Both keys 26 can comprise asymmetrically formed engagement elements 28 which are oriented differently and for example point laterally in opposite directions.

In some embodiments, two keys 26 are each introduced into bores 32b of the column head support 6 extending perpendicular to the vertical axis Z-Z of the lifting cylinder 14. The first key 26 is symmetrical and the second key 26 is asymmetrical, so that the second key 26 comprises an engagement element 28, the longitudinal axis AE-AE of which is offset parallel relative to the longitudinal axis A-A of the main body 27 of this key 26.

In some embodiments, two keys 26 are introduced into bores of the column head support 6, which are slightly offset relative to the vertical alignment of the bores 32b already described. As a result, the respective engagement elements 28 of the two parallel keys 26 are also slightly offset from one another.

The keys 26 disclosed here have various shapes and arrangements, such as, for example, simple or complex keys 26 which are connected to a column head support 6 and are designed for a sliding movement in a groove 24. The keys 26 can optionally be pre-tensioned by a spring or another pre-tensioning element in the direction of and in the groove 24 itself. Such a pre-tension ensures a self-adjusting function of the key position. The position of the keys 26 can be adjustable axially in the direction of the groove 24 and in an opposite direction. This is done either directly or by adjusting a pressure which is exerted on the pre-tensioning element, which in turn presses the key 26 into the groove 24 and pre-tensions it. The adjustment can be made by means of a threaded device such as a screw. The keys 26 can be positioned by receiving them in bores 32a and/or stability bars 25 or using other components. The keys 26 can be arranged vertically adjacent to one another, wherein the vertical distance between the two keys 26 can be in a range of up to 5 cm and in particular in a range of up to 1 cm.

The cylindrical guide 23 is used in various applications. It can be used, for example, to stiffen telescopic elements that have a shape deviating from the cylindrical shape. The cylindrical guide 23 is also used in lifting cylinders 14, 15 which execute a motor-assisted lifting movement or have no direct drive but have a guiding function. The cylindrical guide 23 is also used in operating tables 38 and table columns 1 having a different number of height-adjustable lifting cylinders 14, 15.

The greatest advantage of the design of the table column 1 according to the invention is the complete elimination of the undesired rotational play in the rotational direction around the Z axis. Known cylindrical guide systems for table columns, which are equipped with rotational locks, are either not free of play or not self-readjusting.

In addition, by eliminating the rotational play, the natural frequency of an operating table 38, of which the operating table column 1 is part, increases.

1. A table column (1) for an operating table (38), having:
a column head support (6);
a column head (7) which is received in the column head support (6) and is height-adjustable in relation to it;
a lifting drive (21) for adjusting the height of the column head (7) in relation to the column head support (6); and
a cylindrical guide (23) that connects the column head (7) to the column head support (6) and is used to guide the column head (7) vertically when it is adjusted in height,
wherein the cylindrical guide (23) has a longitudinal groove (24) and two keys (26) engaging therein in order to secure the cylindrical guide (23) against rotation around its vertical axis,
and wherein each key (26) comprises a main body (27) and an engagement element (28) which protrudes along an engagement direction and which engages in the engagement direction in the longitudinal groove (24), wherein the engagement elements (28) of the two keys (26) are arranged offset to one another transverse to the longitudinal axis of the longitudinal groove (24), so that a pre-tension is generated in the cylindrical guide (23) transversely to the longitudinal axis of the longitudinal groove (24).

2. The table column according to claim 1, wherein the offset of the two engagement elements (28) consists of at least one of the engagement elements (28) being arranged eccentrically on its main body (27).

3. The table column according to claim 1, wherein the offset of the two engagement elements (28) consists of the main bodies (27) associated with the engagement elements (28) being arranged on the column head support (6) with an offset to one another.

4. The table column according to any one of the preceding claims, wherein the engagement elements (28) are wedge-shaped.

5. The table column according to any one of the preceding claims, wherein the keys (26) are arranged vertically one above the other along the longitudinal axis of the longitudinal groove (24).

6. The table column according to any one of the preceding claims, wherein each key (26) is assigned a readjusting device (29) for automatic readjustment of its seat within the longitudinal groove (24).

7. The table column according to claim 6, wherein each readjusting device (29) is operated by spring force.

8. The table column according to claim 7, wherein each readjusting device (29) comprises a set of disc springs (30).

9. The table column according to claim 7 or 8, wherein each readjusting device (29) comprises an adjusting screw (31) for adjusting the spring force.

10. The table column according to any one of the preceding claims, wherein the keys (26) are introduced into bores (32b) in the column head support (6).

11. The table column according to any one of the preceding claims, wherein the cylindrical guide (23) comprises a central non-driven lifting cylinder (14), which is passively telescopically adjustable in order to follow the movement of the column head (7) during its height adjustment, and wherein the table column (1) furthermore comprises at least one lifting cylinder (15) drivable by means of the lifting drive (21).

12. The table column according to any one of the preceding claims, further comprising:
an attachment unit (5) arranged at an upper end (la) of the table column (1) for attaching a patient support surface (40) to the table column (I); and
a plurality of lifting cylinders (15);
wherein the cylindrical guide (23) and the lifting cylinders (15) are connected to the attachment unit (5) by means of articulated connections (19, 20); and wherein the cylindrical guide (23) and the lifting cylinders (15) are designed to incline the connection unit (5) around a longitudinal axis of the patient support surface (40) and to tilt it around an axis extending transversely to the longitudinal axis of the patient support surface (40).

13. The table column according to any one of the preceding claims, further comprising a main lifting device (10) which is telescopically adjustable by means of a drive, wherein the main lifting device (10) is designed to vertically adjust the column head support (6) and the cylindrical guide (23) connected to it.

14. The table column according to any one of the preceding claims, wherein the keys (26) are introduced into the column head support (6) and the engagement elements (28) of the keys (26) are pre-tensioned in the longitudinal groove (24) by means of spring force, and wherein the longitudinal groove (24) is designed to slide over the engagement elements (28) of the keys (26).

15. The table column according to any one of the preceding claims, wherein the main bodies (27) of the keys (26) are arranged in the column head support (6); wherein the longitudinal groove (24) is a groove extending vertically in the central lifting cylinder (14) of the column head (7), and wherein the longitudinal groove (24) slides vertically over the engagement elements (28) of the keys (26) when the column head (7) is adjusted in height in relation to the column head support (6).
